(19) United States
(12) Patent Application Publication
(10) Pub. No.: US 2026/0370835 A1
(43) Pub. Date: Nov. 19, 2026

(54) Method and Device for Encoding and Decoding Images

(71) Applicant: ORANGE, ISSY LES MOULINEAUX (FR)

(72) Inventors: Felix HENRY, Chatillon (FR); Theo LADUNE, Chatillon (FR); Pierrick PHILIPPE, Chatillon (FR); Gordon CLARE, Chatillon (FR)

(21) Appl. No.: 19/137,084

(22) PCT Filed: Dec. 5, 2023
(86) PCT No.: PCT/EP2023/084245

§ 371 Date: Jun. 9, 2025

(30) Foreign Application Priority Data
Dec. 9, 2022 (FR) 2213086

(51) Int. Cl. H04N 19/136; H04N 19/13; H04N 19/167; H04N 19/42

(52) U.S. Cl. CPC H04N 19/136; H04N 19/13; H04N 19/167; H04N 19/42

(57) ABSTRACT

A method and device for encoding and decoding a signal including a plurality of samples. The decoding method includes: decoding a first group of feature maps; decoding a set of parameters representative of a neural network; for at least one sample, called the current sample, of the signal to be decoded, associated with a position in the signal to be decoded: constructing a feature vector from the feature maps of the first group, as a function of the position of the current sample, and processing the feature vector with a neural network defined by the decoded parameters in order to provide a vector representative of a decoded value of the current sample.

### DESCRIPTION

### Prior Art

The invention relates to the general field of encoding one-or multi-dimensional signals. It more particularly relates to compression of digital images and video.

Digital images are generally source encoded to compress them in order to limit the resources required for their transmission and/or storage. There are many coding standards, such as, for still images, the standards of the JPEG family, and for moving images, or video, the standards of the ITU/MPEG organizations (H.264/AVC, H.265/HEVC, H.266/VVC, etc.) and their extensions (MVC, SVC, 3D-HEVC, etc.).

An image is generally encoded by dividing the image into a plurality of rectangular blocks, and by encoding these blocks of pixels in a given processing sequence. In existing video compression techniques, processing a block typically comprises predicting the pixels of the block carried out using previously encoded and then decoded pixels present in the image being encoded, in which case “Intra prediction” is referred to, or using previously encoded images, in which case “Inter prediction” is referred to. This use of any spatial and/or temporal redundancies avoids transmitting or storing the value of the pixels of each block of pixels, by representing at least some of the blocks using a residual representing a difference between the prediction values of the pixels of the block and the actual values of the pixels of the predicted block.

Video formats are continuously evolving for even greater compression and to adapt to the variety of expected formats and communication networks, the prediction possibilities are becoming ever greater and the conventional encoding and decoding algorithms are very complex.

In addition to these conventional approaches proposed by the compression standards (JPEG, MPEG, ITU), approaches based on artificial intelligence, and notably neural intelligence, are tending to develop.

Some of these neural approaches can be considered to be a simple extension of the notion of competition of the aforementioned compression techniques, such as the prediction mode competition and video encoding transformation.

Other approaches use the “autoencoder” concept. Autoencoders are artificial neural network-based learning algorithms that allow a new representation of a dataset to be constructed. The architecture of an autoencoder is made up of two parts: the encoder and the decoder. The encoder is made up of a set of layers of neurons, which process the data in order to construct new representations, called “encoded” representations, also called “latent representations”. In turn, the neural layers of the decoder receive these representations and filter them in order to attempt to reconstruct the original data. The differences between the reconstructed data and the initial data allow any errors made by the autoencoder to be measured. The training involves modifying the parameters of the autoencoder in order to reduce the reconstruction error measured on the various samples of the dataset. The performance capabilities of such autoencoder-based systems are achieved at the expense of a considerable increase in the memory footprint and in complexity compared with conventional approaches, such as those proposed by the compression standards. They can have millions of parameters and can require up to one million MAC (multiply-accumulate) operations to decode one pixel. This makes such decoders much more complex than conventional decoders, which could hinder the adoption of learning-based compression.

More recently, a simple coding technique based on a neural network has been described in the article “Compression with Implicit Neural representations” by Emilien Dupont et al. (arXiv:2103.03123). The proposed encoding technique involves adjusting a neural network to an image, quantizing the weights of the network and transmitting them. When decoding, the neural network is evaluated in each pixel position in order to reconstruct the image. Such a technique nevertheless remains inefficient in terms of compression.

A requirement therefore exists for a solution for simply and efficiently encoding/compressing an image or a sequence of images.

### DISCLOSURE OF THE INVENTION

The invention relates to a coding method as claimed in claim 1 and to a decoding method as claimed in claim 8.

Within the meaning of the invention, the term “encoding” or “coding” is understood to mean the operation involving representing a set of samples in a compact form conveyed, for example, by a digital bit stream. Decoding is understood to mean the operation involving processing a digital bit stream in order to render decoded samples.

By “sample” of the signal, what is meant is a value sampled from the signal. Sampling the signal produces a sequence of discrete values, called samples. In the case of an image signal, the sample is called a pixel and may for example be a color pixel conventionally represented by a triplet of values, for example (R,G,B) or (Y,U,V). Generally, a sample is represented by a vector of one or more components, or data.

By “signal comprising a plurality of samples”, what is meant is a signal containing one dimension (audio, sound), two dimensions (image) or more than two dimensions (stereoscopic image, multiscopic image, image associated with a depth map, video, etc.). Depending on this dimensionality, the sample possesses one, two or several coordinates in the signal. In the case of an image signal, the position of the sample is identified by its x- and y-coordinates.

The term “feature maps” is understood to mean an abstract representation of the signal comprising a plurality of potentially discrete, variable data, also called values, real numbers or integers, for example. In a known manner, these maps are also referred to as the “latent representation” of the input signal.

By “data feature vector constructed from the feature maps as a function of a position”, what is meant is a vector consisting of one or more, preferably discrete, elements or data, the data being constructed from the feature maps in a position determined by the position of the sample being processed in the signal. This feature vector is the one input into the neural network. For example, in the case of a one-dimensional audio signal, such a vector can be constructed from a plurality of values sampled in each of the feature maps at the same coordinate as the sample to be encoded. In the case of an image, such a vector can be constructed from a plurality of values sampled in each of the feature maps at the same x- and y-coordinates as the sample to be encoded. It can also be constructed from a plurality of values sampled in each of the feature maps in a position which depends not only on the position of the sample but also on the size of the feature map. Once these values are sampled from the feature maps, they can be processed in order to form the feature vector, before being entered into the neural network, for example, by quantization, filtering, interpolation, etc.

By “neural network”, what is meant is a neural network such as a convolutional neural network, a multilayer perceptron, an LSTM (acronym of Long Short-Term Memory), etc. The neural network is for example defined by a plurality of layers of artificial neurons that comprise a set of activation, weighting and addition functions (for example, one layer may compute y=f(Ax+b), where y and b are vectors of dimension N, x is a vector of dimension M, A is a matrix of dimension M×N, and f is the activation function). Below, reference will be made to “neural network” or “synthetic neural network”.

By “parameter of the neural network” what is meant is one of the values that characterizes the neural network, for example a weight associated with one of the neurons (filter coefficient, weighting, bias, value affecting the operation of the non-linearity), etc.

By “processing by a neural network” what is meant is applying a function expressed by a neural network to the input feature vector, to produce an output vector representative of the sample to be coded (or decoded). This output vector can comprise one or more data representing the sample.

By “performance measurement”, what is meant is a measurement between at least one value of a sample to be coded and a decoded value of said sample. The measurement can evaluate, for example, a distortion, or a perceptual error. It may be performed on one sample or on a plurality of samples (for example, the entire image). The measurement can also comprise a measurement of the bit rate, in particular the bit rate associated with encoding the neural network and/or encoding the feature maps. The measurement can be a joint measurement of the bit rate and the distortion achieved by weighting them. As is well known in the prior art, the value of this measurement is generally minimized until a target value is reached.

By “constructing step”, what is meant is a step that aims to construct parameters representative of the image, before their actual coding. The construction sub-steps can be reiterated as many times as necessary in order to obtain an acceptable performance measurement.

Generally, the steps of an encoding or decoding method should not be interpreted as being associated with a notion of temporal succession. In other words, the steps can be performed in an order different from that indicated in the independent encoding or decoding claim, or even at the same time.

The coding method according to the invention constructs the coding parameters from the input signal, for example an image, by training a neural network on feature vectors associated with a position of a sample to be coded. These feature vectors are constructed from feature maps. During training, or construction, the parameters of the neural network and the values of the feature maps are updated as a function of a performance measurement, for example, of the bit rate-distortion type. When training has ended, i.e. the obtained performance measurement is satisfactory, the actual coding of the parameters of the neural network and/or of the values of the feature maps may be carried out and stored, or transmitted to the decoder.

Advantageously, the training process makes it possible to refine the parameters of the neural network and/or the values of the feature map until a representation that is adequate in performance terms is obtained (for example until a desired balance is obtained between the generated rate and the distortion experienced by the input signal). The training of the values of the feature maps and of the parameters of the neural network can be carried out jointly. Advantageously, the encoding method according to the invention allows the signal to be efficiently compressed.

Advantageously, the decoding method is simple since the feature maps and the neural network simply need to be decoded in order to reconstruct a decoded version of the signal, for example, an image.

Such a neural network advantageously can have a very simple structure with few parameters.

In addition, the decoding can be gradually performed sample by sample.

According to embodiments of the coding and/or decoding method:
The method comprises a step of constructing a second group of feature maps and the feature vector is also constructed from said feature maps. Advantageously, these additional maps of the second group, which are constructed identically in the coder and decoder, are neither stored in the coder or transmitted, nor decoded in the decoder. They thus allow additional data to be used to improve compression without degrading the bit rate. They may for example include coordinates, data available in the maps of the first group, data regarding other images already processed by the coder or decoder, etc.
At least one of the feature maps is of resolution lower than that of the signal to be encoded (respectively to be decoded). Advantageously, according to this embodiment, the compression of the feature maps is more efficient since at least one of the feature maps contains fewer values than if it had the resolution of the signal. For example, in the case of a digital image, one of the feature maps may have a resolution of ½, i.e. it contains half as many x- and y-values as the input signal contains samples, i.e. in total 4 times fewer values than a feature map with the resolution of the signal.
At least one of said feature maps is of resolution identical to that of the signal to be encoded (respectively to be decoded). Advantageously, according to this embodiment, at least one of the feature maps has the same resolution as the input signal (or signal to be decoded), allowing high fidelity and respect of the details of the initial resolution of the signal.
Constructing said feature vector comprises a sub-step of extracting a value from said at least one feature map in an identical position to that of the current sample in the signal.

Advantageously, it is thus possible to extract a value from a feature map of the first or second group, in the same position as the sample in the signal (input signal for the encoding, signal to be decoded for the decoding), in order to construct an element of the feature vector. This method is simple to implement. For example, if J input feature maps are available, with the same resolution as the signal, a simple extraction of the values of the maps at the coordinates of the current sample (on the same abscissa and the same coordinate in the feature map) allows the feature vector of J elements to be directly constructed.
Constructing said feature vector comprises the following sub-steps:
   extracting a plurality of values from the feature maps as a function of said position of said current sample;
   processing said extracted values in order to obtain the feature vector.

Advantageously, it is possible to process the values extracted from the feature maps in order to construct the feature vector. Such processing can correspond, for example, to quantization of the extracted data, or scaling, or filtering, etc. For encoding, quantization is essential for the proper operation of the system if the feature maps include floating, or real, values, for example. They need to be quantized before they are encoded and/or input into the neural network. In contrast, in the decoding, inverse quantization is not necessary, depending on the embodiments.
Encoding (respectively decoding) said first group of feature maps comprises a sub-step of entropy encoding (respectively decoding). Advantageously, entropy coding makes it possible to exploit any signal redundancies that may remain in the feature maps, the signal thus being compressed more efficiently.

Correlatively, the invention also relates to a coding device and a decoding device.

The features and advantages of the coding or decoding method apply in the same way to the coding or decoding device according to the invention and vice versa.

The invention also relates to a computer program on a recording medium, this program being able to be implemented in a computer or controller according to the invention. This program includes instructions designed to implement the corresponding method. This program can use any programming language, and can be in the form of source code, object code, or of intermediate code between source code and object code, such as in a partially compiled format, or in any other desirable format.

The invention also relates to a computer-readable information medium or storage medium comprising instructions for the aforementioned computer program. The information or storage media can be any entity or device capable of storing the programs. For example, the media can include a storage means, such as a ROM, for example a CD-ROM or a microelectronic circuit ROM, or even a magnetic storage means, for example a floppy disk or a hard disk, a DNA sequence, or a flash memory. Moreover, the information or storage media can be transmissible media such as an electrical or optical signal, which can be routed via an electrical or optical cable, by radio link, by wireless optical link or by other means.

The program according to the invention can in particular be downloaded over the Internet.

Alternatively, each information medium or storage medium can be an integrated circuit incorporating the program, with the circuit being designed to execute or to be used to execute a method according to the invention.

### BRIEF DESCRIPTION OF THE DRAWINGS

Further features and advantages of the present invention will become apparent from the following description, with reference to the appended drawings, which illustrate exemplary embodiments thereof that are by no means limiting.

FIG. 1 schematically shows an encoding device used within the scope of the invention;

FIG. 2 schematically shows a decoding device used within the scope of the invention;

FIG. 3 illustrates an example of a synthetic artificial neural network used within the scope of the invention during encoding and decoding;

FIG. 4 is a flow chart representing an example of an encoding method that can be implemented by the encoding device of FIG. 1;

FIG. 5 shows an illustration of an encoding method used in one embodiment of the invention;

FIG. 6 shows an illustration of an encoding method used in another embodiment of the invention;

FIG. 7 is a flow chart representing an example of a decoding method that can be implemented by the decoding device of FIG. 2;

FIG. 8 shows an illustration of a decoding method used in one embodiment of the invention.

### DESCRIPTION OF THE EMBODIMENTS

FIG. 1 schematically shows an encoding device ENC.

This encoding device ENC comprises a module GEN for generating feature maps, a processing and quantizing module TT, a data-extracting module XTR, a module MLP corresponding to an artificial neural network, a module NNC for coding the neural network, a module FMC for coding the feature maps, a module EVAL for evaluating a performance function, an updating module MAJ, and an optional module FME for generating additional feature maps.

The encoding device ENC may be implemented by means of an electronic device comprising a processor and a memory (which have not been shown); each of the above-mentioned modules may then be realized via interaction of the processor and of computer-program instructions that are stored in the above-mentioned memory and designed to perform the functionalities of the module in question, in particular as described below, when these instructions are executed by the processor.

The coding device ENC of FIG. 1 receives as input a succession of samples to be coded, denoted Pₙ, for example a temporal succession of sound samples, or a set of image data denoted I(Pₙ). In the second case, the image signal I(Pₙ) may represent a two-dimensional image, or a plurality of two-dimensional images (video, color components, stereoscopic components, multiscopic components, etc.). Pₙ denotes one sample n of the input signal, which comprises N samples. In one embodiment, the signal is a color-image signal represented by means of at least one two-dimensional representation, such as a matrix of pixels, of width W and of height H (with N=W×H), each pixel having one red component (R), one green component (G), and one blue component (B), or as a variant, one brightness component (Y) and at least one chroma component. The location of each pixel is defined by its x- and y-coordinates (x and y) in the image. In one embodiment, the image is greyscale and represented by means of a two-dimensional representation, such as a matrix of pixels, each pixel having a greyscale or brightness component. In this case, the vector representative of the pixel is reduced to a single component, or datum.

As will be described in greater detail hereafter with reference to FIGS. 3 to 8:

The module GEN for generating feature maps is configured to generate, and in particular initialize, a plurality of M feature maps denoted FMᵢ. The optional module FME can generate one or more additional maps (L in number), which will neither be encoded nor transmitted, and which are denoted FMEₗ.

The module XTR extracts values in the feature maps FMᵢ and optionally FMEᵢ, for a sample Pₙ to be coded, as a function of its coordinates in the input signal.

The module TT processes the extracted values in order to generate the vector Zₙ. Zₙ is a J-tuple, i.e., it contains J elements, or data zᵢ. The vector Zₙ of index n refers to the feature vector of the pixel P′ₙ.

The module TT quantizes the data extracted from this set of M maps FMᵢ, or from the vector Zₙ constructed from these data. To prepare for further encoding (for example entropy encoding), the encoding system quantizes the latent representation of the input data using a quantizer Q to generate an ordered collection of quantized values. It should be noted that the quantization of a value refers to matching this value with a member of a discrete set of possible code symbols. For example, the set of possible code symbols can be made up of integer values, and the quantization system simply rounds an actual value to an integer value. According to another example, quantization involves multiplication by a given value and then rounding.

The module MLP is a neural network that is defined by K parameters Wₖ, and that is capable of receiving the vector Zₙ, or J-tuple, as input, to generate as output a second vector representative of the sample Pₙ to be coded. According to one embodiment, the neural network is an MLP, or multilayer perceptron, consisting of an input layer adapted to the input format (the J-tuple), optionally one or more hidden layers, and an output layer adapted to the output format of the output vector, generally a vector containing A elements. According to one embodiment, A is equal to 3 and the output vector is the (R,G,B) triplet of the pixel P′ₙ coded and then decoded.

The module NNC encodes the neural network, notably its parameters Wₖ. During the encoding training or construction process, i.e., as long as the step of evaluating performance remains unsatisfactory, the module NNC simulates the encoding, followed by decoding, the results of which are sent to the evaluating module. The evaluation module updates the values of the parameters as a function of the results of a performance measurement carried out by the module EVAL. Subsequently, it carries out the actual encoding of the parameters Wₖ of the neural network. The encoded parameters are denoted Wcₖ. In a known manner, the encoding simulation can be identical to the actual encoding, or can approximate it.

The module FMC codes the maps FMi, i.e. quantized values of each map of the first group (excluding the maps FMEₗ). During the encoding training or construction process, i.e., as long as the step of evaluating performance remains unsatisfactory, the module FMC simulates the encoding, followed by decoding, the results of which are sent to the evaluation module. Subsequently, it performs the actual encoding of the values of the maps FMᵢ. The encoded maps are denoted FMcᵢ. In a known manner, the encoding simulation can be identical to the actual encoding, or can approximate it. The encoding module compresses the quantized data using entropy encoding, for example.

The module EVAL performs an evaluation and minimization of an encoding performance. The evaluation function is of the bit rate-distortion type, for example. The minimization can be performed via a gradient descent, or any other method within the ability of a person skilled in the art.

The module MAJ updates the FMI map values to be coded as a function of the results of the performance function. Optionally, it can update the values of the additional maps FMEₗ.

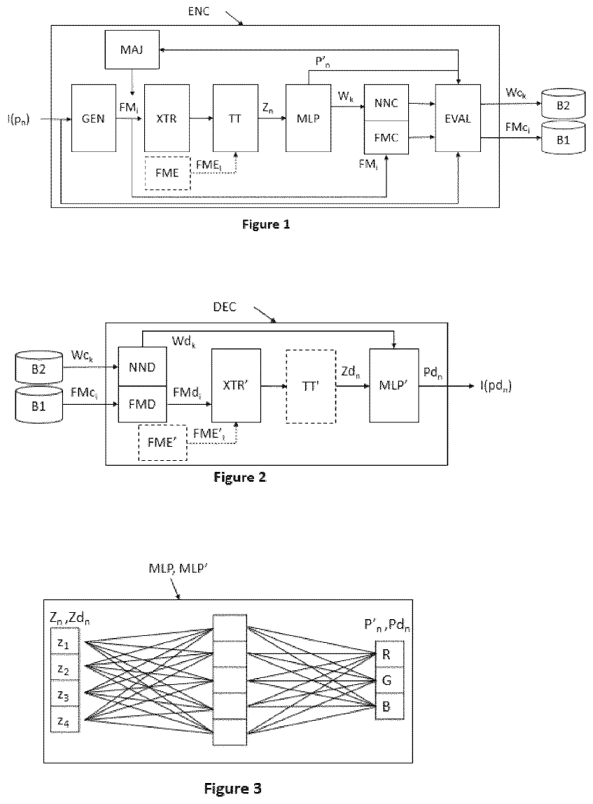

FIG. 2 schematically shows a decoding device DEC.

The encoding device DEC of FIG. 2 receives as input a first group of encoded data organized into M feature maps FMcᵢ (also called layers FM) and the encoded parameters Wcₖ of the neural network.

This decoding device DEC comprises a module NND for decoding the neural network, a module FMD for decoding the feature maps, a data-extracting module XTR′, an inverse processing module TT′, a module MLP′ corresponding to a neural network, and an optional module FME′ for generating additional feature maps.

The maps decoded by the module FMD, M in number, are denoted FMdᵢ. The parameters decoded by the module NND are denoted Wdₖ.

The module FME′ of the decoder can also generate one or more additional maps, denoted FME′₁, L in number, and which are identical to the additional maps FMEₗ generated by the encoder.

The module XTR′ is identical to the module XTR of FIG. 1. It extracts values from the M decoded feature maps FMdᵢ, and optionally from the L additional maps FME′ₗ, to construct the vector Z, which takes the form of a J-tuple for a sample Pₙ to be decoded, as a function of its coordinates in the signal to be decoded. In one embodiment, J=M. In one embodiment, J=M+L.

The module TT′ optionally performs an inverse quantization corresponding to the quantization performed on the encoder. The inverse quantization is not necessary if the quantizer Q of the encoder simply rounded the actual values it received. The inverse quantization is not necessary if the neural network is able to take into account quantization of its input data. Otherwise, the decoder performs the inverse operation of the quantizer Q. Moreover, like the module TT of the encoder, the module TT′ optionally processes the values extracted from the feature maps, to generate the decoded vector Zdₙ.

The module MLP′ is a neural network that is defined by K parameters Wdₖ, and that is capable of receiving the vector Zdₙ, or J-tuple, as input, to generate as output a second vector representative of the sample Pa to be decoded, generally a vector containing A elements. According to one embodiment, A=3 and the output vector is the (R,G,B) triplet of the decoded pixel Pdₙ. The module MLP′ has an identical structure to the module MLP, and its parameters are either identical if the encoding of its parameters Wₖ is lossless, or different if the encoding is lossy.

When all the samples Pₙ of the signal have been decoded, a reconstructed signal I(Pdₙ) is obtained, according to one example an image I comprising N decoded samples taking the form of N vectors Pdₙ.

The decoding device DEC may be implemented by means of an electronic device comprising a processor and a memory (which have not been shown); each of the above-mentioned modules may then be realized via interaction of the processor and of computer-program instructions that are stored in the above-mentioned memory and designed to perform the functionalities of the module in question, in particular as described below, when these instructions are executed by the processor.

FIG. 3 illustrates one example of a synthetic artificial neural network used for encoding and decoding within the context of embodiments of the invention.

The synthetic artificial neural network MLP used for encoding and the synthetic artificial neural network MLP′ used for decoding are defined by an identical structure, for example, comprising a plurality of layers of artificial neurons, and by a set of weights and activation functions respectively associated with the artificial neurons of the network in question.

A vector representation of a current sample (a vector Zₙ or Zdₙ obtained from the feature maps FMᵢ and FMEₗ or FMdᵢ and FME′ₗ) is applied to the input (i.e. to an input layer) of the synthetic artificial neural network MLP or MLP′. The artificial neural network produces as output a vector P′ₙ or Pdₙ representative of the decoded sample, according to one embodiment the constituent color components (R,G,B) of a color pixel of an image.

The concatenation of all these reconstructed pixels into a (2D, 3D) image forms the decoded or reconstructed image.

In the coder, the synthetic artificial neural network MLP is trained on the image, so as to minimize the differences between the input representation of the current image I(Pₙ) and its output representation I(P′ₙ), while also minimizing the amount of data to be coded. The module EVAL performs a performance measurement in this sense.

Once the training has ended, the parameters of the network are encoded either losslessly, in which case the neural network MLP′ is identical to MLP, or with losses, in which case the network MLP′ can be slightly different from MLP.

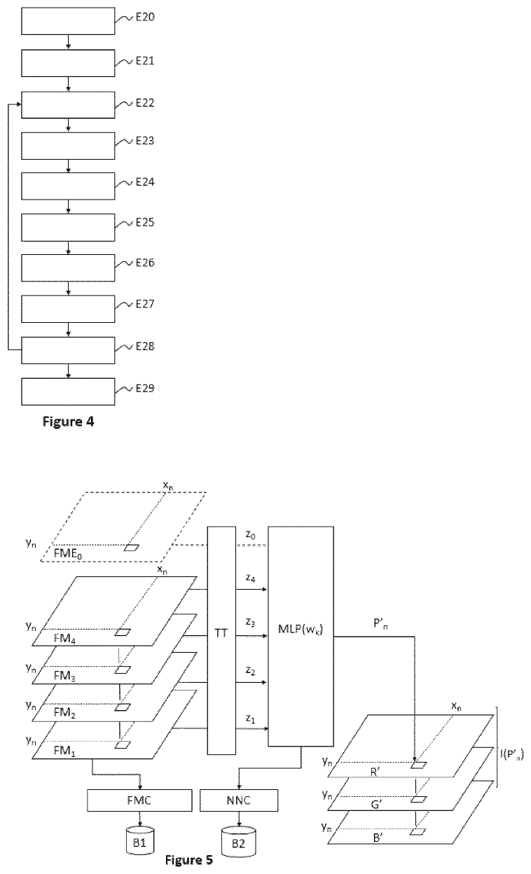

FIG. 4 is a flowchart showing an example of an encoding method that can be implemented by the encoding device of FIG. 1.

According to this embodiment, the signal is a two-dimensional image, each sample to be encoded is therefore a pixel Pₙ of coordinates (xₙ, yₙ).

Encoding takes place in two main phases:

In a first phase, called construction phase, learning is performed, in order to determine, for an input signal I(Pₙ), the values of the maps FMᵢ and parameters Wₖ in order to optimize an overall cost function. The learning is, for example, carried out via gradient descent, followed by an update of the parameters of the neural network MLP and of the values of the feature maps FMᵢ. As is known in the prior art, the cost function can be of the bit rate-distortion type, or can be of the bit rate, or distortion, or perceptual type. In order to measure the bit rate R, the encoding of the maps FMᵢ needs to be simulated, then the associated encoding bit rate (the size of the stream B1) needs to be measured. According to one embodiment, the encoding of the parameters Wₖ is not simulated because their influence is less than that of the feature maps. According to one embodiment, the encoding of the parameters Wₖ is also simulated and the associated bit rate (the size of the stream B2) is measured. In order to measure the distortion D, the encoding and then the decoding of at least one part of the image I needs to be simulated in order to obtain at least one pixel P′ₙ resulting from a simulation of encoding and then decoding, then the difference between this part of the input image I(Pₙ) and a corresponding part of the encoded and then decoded image I(P′ₙ) needs to be measured.

Next, during a second phase, called encoding phase, the maps FMᵢ and the parameters Wₖ are encoded to produce the encoded values FMcᵢ and Wcₖ before transmission or storage. They form the compressed representation of the input signal I(Pₙ).

The steps of a method according to one embodiment of the invention will now be described.

In a step E20, a signal I(Pₙ) to be coded, comprising a plurality of N samples Pₙ, is delivered as input to the method.

In a step E21, the M maps FMᵢ of the first group are initialized by the module GEN. Subsequently, the parameters Wₖ of the neural network MLP and the values of the maps FMᵢ must be optimized during the construction phase.

According to one embodiment, the maps FMᵢ have the same resolution as the input signal I(Pₙ) and therefore each comprise the same number of values N as there are samples Pₙ to be coded.

According to one embodiment, the maps FMᵢ have a resolution less than or equal to the input signal I(Pₙ) and therefore at least one of them comprises a number N′ of values to be coded less than N.

According to one embodiment, the first map FMᵢ has the resolution of the signal and each subsequent map has a resolution of half the previous one.

According to one embodiment, a plurality of maps FMᵢ have the same resolution, less than the resolution of the signal.

According to one embodiment, the maps FMᵢ are initialized with predefined constant values.

According to another embodiment, the feature maps are initialized with a set of random real values.

According to one embodiment, one or more maps FMEₗ, forming a second group of L additional feature maps, are generated and added to the first group. They are used to construct the feature vector but will not be stored or transmitted.

These feature maps FMᵢ of the first group are subsequently updated, or refined, in a step E22 by the updating module MAJ of the coder during its learning in the construction phase.

In a step E23, the maps FMᵢ of the first group are coded by the module FMC of the coder. During the construction phase, this operation is an encoding simulation. During the encoding phase, this operation is actual encoding and the encoded values form the stream B1. The simulation can be identical to the actual encoding, but it also can be different (for example, simplified). For this encoding, it is possible to use any known technique aimed at compressing the values of the maps.

In one embodiment, the maps FMᵢ are encoded in the order (FM₁, FM₂, . . . , FM₄), and the variables of each map are encoded in a predefined order, in a lexicographic order, for example. Each map undergoes entropy encoding. The entropy encoding produces a compressed stream B1, the bit rate of which is subsequently measured during a step E28.

During a step E24, values from the maps FMᵢ and optionally FMEₗ are extracted by the module XTR. This extraction is performed as a function of the coordinates (xₙ, yₙ) of the sample Pₙ of the input signal.

According to one embodiment, the coordinate values (xₙ, yₙ) of each map are extracted.

According to one embodiment, the coordinate values are scaled to extract the layers of lower resolution.

According to one embodiment, values close to those mentioned above are also extracted for the subsequent processing of step E25.

During a step E25, a vector Zₙ is constructed by the module TT from the values extracted from the maps FMᵢ and optionally Fme for each sample Pₙ of coordinates (xₙ, yₙ) of the input signal. The processing includes quantization of the values extracted from the maps FMᵢ, if necessary. The processing can include other operations, such as filtering, scaling, applying any function, preferably a monotonous function, etc.

In one embodiment, Zₙ comprises as many values as there are input maps or maps FMi (and optionally FMEₗ). In this case, J=M(+L).

In one embodiment, Zₙ is a J-tuple (z₁, z₂, . . . , z_{J}) formed from the values of the maps FMᵢ (and optionally FMEₗ) located at the coordinates (xₙ, yₙ) of the current pixel Pₙ, as will be illustrated with reference to FIG. 5. The value located at the coordinates (xₙ, yₙ) of the map FMᵢ gives the final value (zᵢ) of the element i of the vector Zₙ relating to this map FMᵢ or FMEₗ. In this case, the module TT does not apply any processing other than quantization.

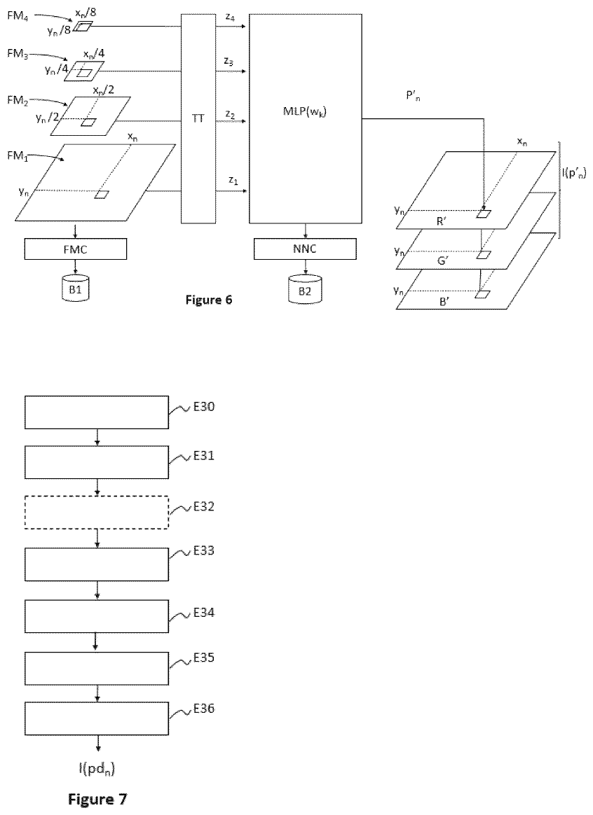

In one embodiment, Zₙ is a J-tuple constructed from values sampled from the maps FMi (and optionally FMEₗ) at coordinates that can differ depending on the maps. For example, if the maps FMᵢ (and/or FMEₗ) have different resolutions because they have been down-sampled, the coordinates are adapted (by scaling) to match the resolution of each map, as will be illustrated with reference to FIG. 6.

In one embodiment, Zₙ is a J-tuple constructed from values sampled from the maps FMᵢ (and FMEₗ) by applying the processing to one or more values of the maps, for example filtering neighboring values of the targeted value in a map. For example, in a map FMᵢ that has the same resolution as the input signal, it is possible to extract the values located at the coordinates (xₙ, yₙ), (xₙ−1, yₙ), (xₙ, yₙ−1) and (xₙ−1, yₙ−1) and to process these values (filtering, averaging, interpolation, etc.) in order to obtain the final value (zᵢ) of the element i of the vector Zₙ relating to this map FMᵢ or FMEₗ. According to another example, in a map FMᵢ that has half the resolution of the input signal, the values located at the coordinates (xₙ/2, yₙ/2), (xₙ/2−1, yₙ/2), (xₙ/2, yₙ/2−1) and (xₙ/2−1, yₙ/2−1) can be considered and these values can be processed (filtering, averaging, interpolation, etc.) in order to obtain the final value (zᵢ) of the element i of the vector Zₙ relating to this map FMᵢ or FMEₗ.

The samples to be encoded are, for example, processed in sequential order, from n=1 to n=N.

In a step E26, the vector Zₙ is processed by the neural network MLP to generate as output a vector representative of the sample Pₙ to be coded, according to one embodiment the (R, G, B) triplet of the sample P′ₙ (the sample Pₙ coded and then decoded).

The structure and the parameters Wₖ of the neural network are initialized, for example, in the first iteration of this step. These parameters are subsequently updated, or refined, during the construction phase, during subsequent iterations of the method.

According to one embodiment, the parameters of the neural network are initialized with predefined values known to give a satisfactory result (for example, following training on a corpus of images).

According to another embodiment, the parameters Wₖ of the neural network are initialized with a set of random values.

In a step E27, the parameters Wₖ of the neural network MLP are quantized and coded. During the construction phase, this operation is an encoding simulation. During the encoding phase, this operation is actual encoding and the encoded values form the stream B2. The simulation can be identical to the actual encoding, but it also can be different (for example, simplified). To this end, any known technique can be used, for example, the neural network coding standard proposed in part 17 of the MPEG-7 standard, also called Neural Network Representation or NNR. It should be noted that in this case, the amount of degradation that the encoding causes to the parameters Wₖ needs to be selected.

In a step E28, a performance measurement is evaluated.

To this end, the coding simulation rates associated with the feature maps (simulation of the stream B1 by coding and decoding the maps FMᵢ) and optionally with the parameters of the neural network (simulation of the stream B2 by coding and decoding the parameters Wₖ) are measured.

According to one embodiment, the cost function is of the rate-distortion type, denoted (D+L*R), where D is for example the squared error measured between the input signal and the decoded signal (or the error measured on a subset of samples of the signal). According to another example, D is computed from a perceptual function such as SSIM (Structural SIMilarity), or MSSSIM (Multi-scale Structural SIMilarity). According to one embodiment, R is the simulated bit rate of the stream B1; according to another embodiment, R is the total bit rate used to encode this image, i.e., the sum of the simulated bit rates of B1 and B2. L is a parameter that adjusts the rate-distortion compromise. Other cost functions are possible.

Until the cost function reaches its minimum, the performance measurement remains unsatisfactory, and the method is repeated from step E22. This minimization can be carried out via a known mechanism such as gradient descent with parameters updated in step E22 as regards the values of the feature maps and step E26 as regards the parameters of the network.

In a step E29, if the cost function has reached its minimum, the training stops. If an encoded version corresponding to the last simulation of the parameters of the neural network (Wₖ) and of the feature maps (FMᵢ) is available, the streams B1 and B2 can be formed therefrom. According to another embodiment, the actual encoding of the updated parameters of the neural network (Wₖ) and of the values of the feature maps (FMᵢ) is carried out in this step to produce the encoded parameters Wcₖ and FMcᵢ forming the streams B1 and B2.

The streams B1 and B2 can be concatenated to produce a final stream BS. According to one embodiment, the stream B2 of the encoded parameters of the neural network is stored or transmitted before the stream B1, in order to be able to be decoded before the stream B1.

FIG. 5 illustrates a coding method used in one embodiment of the invention to code an image I(Pₙ) (not shown).

In this embodiment, the maps FMᵢ are 4 in number. In one preferred embodiment, they are 7 in number. The maps FMᵢ have the same resolution as the image I(Pₙ), and therefore each comprise W×H values, where W represents the width of the image in pixels and H its height (N=W×H).

In a variant drawn with dotted lines, the feature maps are 5 in number: an additional map FME₀ has been introduced, which will neither be stored nor transmitted. This additional map typically includes data that can assist the network MLP with the task of reconstructing the signal. Thus, the added maps can be one or more maps from the following non-limiting list:
A map containing, at each point, the x-coordinate of this point.
A map containing, at each point, the y-coordinate of this point.
A map containing positional coding at each point (as described for example at the Internet address https://skosmos.loterre.fr/P66/fr/page/-K0D65X2X-X).
A map representing an image distinct from the image being processed, and capable of providing information on the image to be coded (for example the previously processed image if the current image forms part of a series of images to be coded such as a video, a set of medical images, a multiview representation, etc.).
A map representing a feature map of an image distinct from the image being processed, and capable of providing information on the image to be coded (for example a previously processed map if the current image forms part of a series of images to be coded such as a video, a set of medical images, a multiview representation, etc.).
A map containing the value of an already decoded sample of the same map, for example the previous sample in the decoding order.

In this embodiment, the vector Zₙ is a 4-tuple (z₁ . . . z₄) formed from values extracted from the maps FMᵢ located at the coordinates (xₙ, yₙ) of the current pixel Pₙ. The extracted values are quantized by the module TT and the vector Zₙ formed from the quantized values is processed by the neural network MLP to generate as output a second vector, in the example an (R, G, B) triplet representative of the sample Pₙ to be coded. The output vector is in this case the (R,G,B) triplet of the pixel P′ₙ coded and then decoded. The triplet is inserted into the decoded image I(P′ₙ) at the positions (xₙ, yₙ) of the color components (R′, G′, B′).

According to one embodiment, the 4 maps FMᵢ are quantized.

According to the variant shown as dashed lines, the vector Zₙ is a 5-tuple (z₀ . . . z₄), with the value z₀ being extracted from the additional map FME₀.

FIG. 6 shows an illustration of an encoding method used in another embodiment of the invention.

In this embodiment, the maps FMᵢ are 4 in number. As in the preceding embodiment, the first map FM₁ has the same resolution as the image I, and therefore contains W×H values, where W represents the width of the image in pixels, and H its height. The second map FM₂ has half the resolution (in each dimension) of the map FM₁. Each additional map has half the resolution of the previous map. This structure allows the number of variables in the feature maps to be decreased, thus facilitating encoding and learning, while minimizing the encoding cost.

In this embodiment, a 4-tuple Zₙ is constructed from the values of the maps FMᵢ located respectively at the coordinates (xₙ, yₙ), (xₙ/2, yₙ/2), (xₙ/4, yₙ/4), (xₙ/8, yₙ/8) of the current pixel Pₙ (xₙ, yₙ). These extracted values are processed and quantized to generate the 4-tuple Zₙ. According to one embodiment, for the map FM₂, the value located at the coordinates (xₙ/2, yₙ/2) is extracted to obtain the final value (z₂) of the vector Zₙ relating to this map FM₂. According to another embodiment, for the map FM₂, the values located at the coordinates (xₙ/2, yₙ/2), (xₙ/2−1, yₙ/2), (xₙ/2, yₙ/2−1), (xₙ/2−1, yₙ/2−1) are extracted and they are filtered to obtain the final value (z₂) of the vector Zₙ relating to this map FM₂. Oversampling is performed in this manner. The filtering or oversampling may, for example, use bicubic filtering or Lanczos filtering, which are known per se. More general processing can also be used: a neural network can be used to produce the final value (z₂) by weighting the values located at the coordinates (xₙ/2, yₙ/2), (xₙ/2−1, yₙ/2), (xₙ/2, yₙ/2−1), (xₙ/2−1, yₙ/2−1), for example a network of MLP type.

As above, the vector Zₙ is processed by the neural network MLP to generate as output a second vector, here an (R, G, B) triplet representative of the sample Pₙ to be coded. The output vector is in this case the (R,G,B) triplet of the pixel P′ₙ coded and then decoded. The (R, G, B) triplet is reinjected into the decoded image at the positions (xₙ, yₙ) of the color components (R′, G′, B′) of the image I(p′ₙ).

Other types of structure are possible, for example a reduction rate different from one half between the maps (one quarter, or one third, etc.) can be used. The oversampling step is then adapted to produce the final value of the vector Zn.

As has been described with reference to FIG. 5, other maps FMEₗ can be introduced, which will be used to generate the vector Zₙ but will not be stored or transmitted.

FIG. 7 is a flow chart showing an example of a decoding method that can be performed by the decoding device of FIG. 2.

During a step E30, the streams B1 and B2 are extracted from the encoded stream BS. They respectively contain the encoded representations of the maps of the first group FMcᵢ and of the parameters Wcₖ.

During a step E31, the M maps FMdᵢ are generated by decoding the values FMcᵢ. For this decoding, any known technique can be used that is similar to that used in the encoder, and preferably entropy decoding. In one embodiment, the maps FMdᵢ are decoded in the order (FMd₁, FMd₂, . . . , FMd₄), and the variables of each map are decoded in a predefined order, for example, in a lexicographic order.

According to one embodiment as described for the encoder, the maps FMdᵢ have the same resolution as the signal I(Pdₙ) to be reconstructed, i.e. they contain N values.

According to an embodiment equivalent to that described for the coder, the maps FMdᵢ have a resolution less than or equal to the signal I(Pdₙ) to be reconstructed.

According to an embodiment equivalent to that described for the coder, a plurality of maps FMdᵢ have the same resolution, lower than the resolution of the signal.

During a step E32, according to one embodiment, one or more maps FME′ₗ, forming a second group of L additional feature maps, are generated and added to the first group. They are not decoded, but are generated by the decoder in the same way they are generated in the encoder. They typically include data that can assist the network MLP′ in the task of reconstructing the signal. The non-limiting list of possible additional feature maps described with reference to FIG. 5 for the encoder is also applicable in this case.

During a step E33, values are extracted by the module XTR′ from the maps FMdᵢ and possibly FME′ₗ. This extraction is carried out as a function of the coordinates (xₙ, yₙ) of the input signal of the sample Pₙ of the signal to be reconstructed. This step is identical to step E24 that was described for the encoder with reference to FIG. 4 and the described embodiments are applicable.

The samples to be decoded are processed, for example, in sequential order, from n=1 to n=N.

During a step E34, a vector Zdₙ is constructed by the module TT′ from the values extracted from the maps FMdᵢ and possibly FME′ₗ for a sample Pₙ to be decoded of coordinates (xₙ, yₙ). The processing can include an inverse quantization of the extracted values or of the formed vector Zdₙ, if necessary. The processing can include other operations, such as filtering, scaling, etc. This step is identical to step E25 which has been described for the encoder with reference to FIG. 4 and the embodiments described apply. However, inverse quantization is not mandatory. In this particular case, step E34 and the module TT′ are therefore optional.

In a step E35, the parameters Wdₖ of the neural network MLP′ are generated by decoding the values Wcₖ of the stream B2. To this end, any known decoding technique corresponding to the coding technique used by the coder may be used. The neural network MLP′ is similar to the network MLP, i.e. it has the same structure and the same parameters, disregarding the coding, which may be lossy or lossless.

According to one embodiment, the stream B2 is decoded before the stream B1, in order to obtain the neural network before starting to decode samples.

During a step E36, the vector Zdₙ is processed by the neural network MLP′ to generate as output a second vector representative of the sample Pdₙ to be decoded, according to one embodiment a triplet that is injected into the decoded image I(Pdₙ) at the positions (xₙ, yₙ) of the color components (Rd, Gd, Bd). This step is identical to step E26 that was described in the context of the coder with reference to FIG. 4.

When all the samples of the signal have been processed, the decoded signal corresponding for example to the image I(Pdₙ) is obtained.

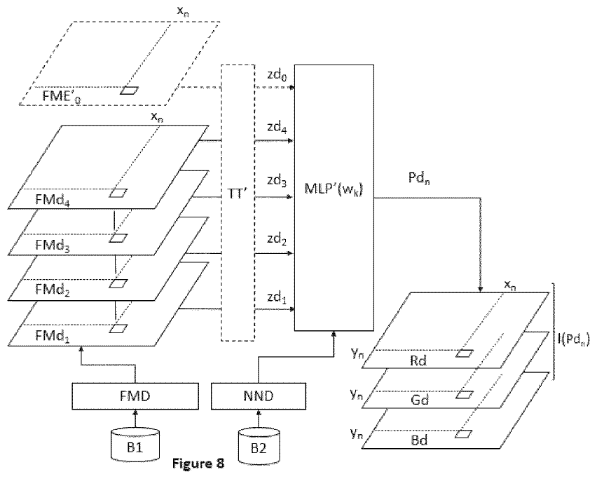

FIG. 8 illustrates a decoding method used in one embodiment of the invention to decode an image I(Pdₙ).

In this embodiment, the maps FMdᵢ are 4 in number. In one preferred embodiment, they are 7 in number.

In this embodiment, the maps FMdᵢ have the same resolution as the image to be decoded, and therefore contain W×H variables, where W represents the width of the image in pixels, and H its height.

In this embodiment, the vector Zdₙ is a 4-tuple (z₁ . . . z₄) formed from the values of the maps FMdᵢ located at the coordinates (xₙ, yₙ) of the current pixel Pdₙ. The vector Zdₙ is optionally dequantized and then processed by the neural network MLP′ to generate as output a second vector, according to the example an (R, G, B) triplet representative of the sample Pdₙ to be decoded. The (R, G, B) triplet is reinjected into the decoded image I(Pdₙ) at the coordinates (xₙ, yₙ) in the color components (Rd, Gd, Bd).

According to a variant shown as dashed lines, the maps are 5 in number: an additional map FME′₀ has been introduced. In this embodiment, the vector Zdₙ is a 5-tuple.

1. A method for coding a signal comprising a plurality of samples to be coded, the method being implemented by an encoding device and comprising:
constructing a first group of feature maps;
for at least one sample, called current sample, of the signal to be coded, which is associated with a position in the signal to be coded:
constructing a feature vector from said feature maps of said first group, as a function of said position of said current sample;
processing said feature vector with a neural network defined by a set of parameters, in order to provide a vector representative of a decoded value of the current sample; and
updating at least one value of one of said feature maps of said first group and/or at least one parameter of said network, as a function of a coding performance measurement; and
coding said first group of feature maps and said set of parameters.

2. The method for coding a signal as claimed in claim 1, wherein the method comprises constructing a second group of feature maps and wherein the feature vector is further constructed from said feature maps of the second group.

3. The method for coding a signal as claimed in claim 1, wherein at least one of said feature maps is of resolution lower than that of the signal to be coded.

4. The method for coding a signal as claimed in claim 1, wherein at least one of said feature maps is of identical resolution to that of the signal to be coded.

5. The method for coding a signal as claimed in claim 1, wherein constructing said feature vector comprises extracting a value from said at least one feature map in an identical position to that of the current sample in the input signal.

6. The method for coding a signal as claimed in claim 1, wherein constructing said feature vector comprises:
extracting a plurality of values from said feature maps as a function of said position of said current sample;
processing said extracted values in order to obtain the feature vector.

7. The method for coding a signal as claimed claim 1, wherein coding said first group of feature maps comprises entropy coding.

8. A method for decoding a signal comprising a plurality of samples to be decoded, the method being implemented by a decoding device and comprising:
obtaining, by decoding, a first group of feature maps;
obtaining, by decoding, a set of parameters representative of a neural network and
for at least one sample, called the current sample, of the signal to be decoded, which is associated with a position in the signal to be decoded:
constructing a feature vector from the feature maps of said first group, as a function of said position of said current sample, and
processing said feature vector with the neural network in order to provide a vector representative of a value of the current sample.

9. The method as claimed in claim 8, wherein the method comprises constructing a second group of feature maps and wherein the feature vector is further constructed from said feature maps of the second group.

10. The method as claimed in claim 8, wherein at least one of said feature maps is of resolution lower than that of the signal to be decoded.

11. The method for decoding a signal as claimed in claim 8, wherein at least one of said feature maps is of identical resolution to that of the signal to be decoded.

12. The method for decoding a signal as claimed in claim 8, wherein constructing said feature vector comprises extracting a value from said at least one feature map (FMdᵢ, FME′ᵢ) in an identical position (xₙ, yₙ) to that of the current sample (Pdₙ) in the signal to be decoded.

13. The method for decoding a signal as claimed in claim 8, wherein constructing said feature vector comprises:
extracting a plurality of values from the feature maps as a function of said position of said current sample;
processing said extracted values in order to obtain the feature vector.

14. The method for decoding a signal as claimed in claim 8, wherein decoding said first group of feature maps comprises entropy coding.

15. A device for coding a signal comprising a plurality of samples to be coded, wherein said device comprises:
at least one processor; and
at least one non-transitory computer readable medium comprising instructions stored thereon which when executed by the at least one processor configure the device to:
construct a first group of feature maps;
for at least one sample, called current sample, of the signal to be coded, which is associated with a position in the signal to be coded:
construct a feature vector from said feature maps of said first group, as a function of said position of said current sample, and
process said feature vector with a neural network defined by a set of parameters in order to provide a vector representative of a decoded value of the current sample; and
update at least one value of one of said feature maps of said first group and/or at least one parameter of said network, as a function of a coding performance measurement; and
code said first group of feature maps and said set of parameters.

16. A device for decoding a signal comprising a plurality of samples to be decoded, wherein said device comprises:
at least one processor; and
at least one non-transitory computer readable medium comprising instructions stored thereon which when executed by the at least one processor configure the device to:
obtain, by decoding, a first group of feature maps;
obtain, by decoding, a set of parameters representative of a neural network; and
for at least one sample, called the current sample, of the signal to be decoded, which is associated with a position in the signal to be decoded:
construct a feature vector from the feature maps of said first group, as a function of said position YA)of said current sample, and
process said feature vector (Zdₙ) with said neural network in order to provide a vector representative of a value of the current sample.

17. A non-transitory computer readable medium comprising a computer program stored thereon comprising instructions for executing a coding method as claimed in claim 1 when said program is executed by a computer.

18. A non-transitory computer readable medium comprising a computer program stored thereon comprising instructions for executing a decoding method as claimed in claim 8 when said program is executed by a computer.
